(19) United States
(12) Patent Application Publication
(10) Pub. No.: US 2005/0152296 A1
(43) Pub. Date: Jul. 14, 2005

(54) Internet protocol tuner for classifying internet packets into broadcasting packets and communication packets and method therefor

(76) Inventors: Sangjae Lee, Daejon (KR); Intark Han, Daejon (KR); Sung-Il Nam, Daejon (KR); Yong-Il Jun, Daejon (KR); Hyeong-Ho Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/848,945

(22) Filed: May 19, 2004

(30) Foreign Application Priority Data
Dec. 27, 2003 (KR) 2003-98347

(51) Int. Cl. H04H 1/00

(52) U.S. Cl. 370/312

(57) ABSTRACT

Provided are an Internet protocol tuner that can classify Internet packets transmitted through the Internet into broadcasting packets and communication packets based on channel selecting information and extract transport stream from the broadcasting packets, and a method therefor. The Internet protocol tuner of the present research includes: a network interface unit for receiving an Internet packet; a packet classifying unit for classifying the Internet packets received; a transport stream extracting unit for extracting transport stream from the broadcasting packet; a transport stream transmitting unit for transmitting the transport stream; a transport stream receiving unit for receiving the transport stream from the decoding unit; a controller interface unit for receiving control information including channel selecting information from an external controller; and a tuning control unit for controlling the packet classifying unit, and controlling the transport stream extracting unit.

### FIELD OF THE INVENTION

The present invention relates to an Internet protocol tuner having a function of classifying Internet packets into broadcasting packets and communication packets and a method therefor; and, more particularly, to an Internet protocol tuner that can extract transport stream from digital broadcasting packets by classifying Internet packets, which are transmitted through the Internet based on channel selecting information, into broadcasting packets and communication packets and convert transport stream transmitted from a decoder for a digital television into Internet packets, and to a method therefor. Herein, packets transmitted and received using an Internet protocol is referred to as Internet packets. The transport stream can be referred to as broadcasting traffics.

### DESCRIPTION OF RELATED ART

Recently, digitalization of broadcasting media are being speeded up even more, especially among some highly developed countries. Nation-wide terrestrial television service (TV) is launched in England in September 1998 for the first time in the world. In November, the same year, four U.S. broadcasting stations launched the terrestrial digital TV broadcasting service in four major cities.

Ever since, the terrestrial digital TV broadcasting service is introduced to major advanced countries, such as Germany, France and Japan. In Korea, a test broadcasting service for the terrestrial digital TV broadcasting service began in November 2000. At the end of 2001, a regular terrestrial digital TV broadcasting service began in the national capital region. In 2003, the service has been expanded to large cities and it will widen its coverage into the entire nation gradually by 2005.

The digitalization of satellite broadcasting service antedates that of the terrestrial broadcasting service. In the U.S., the age of digital satellite broadcasting service has started on a full scale in June 1994, as two broadcasting stations DirecTV and United States Satellite Broadcasting (USSB) began providing a 150-channel service and a 25-channel service, respectively.

In Europe, a French broadcasting station Canal+ began the first digital satellite broadcasting service in April 1996, followed by a German broadcasting station Kirch is providing digital satellite broadcasting service since June 2000.

Japan also began the digital satellite broadcasting service utilizing a communication satellite almost at the same time as Europe, which is June 1996. At present, the number of subscribers to the digital satellite broadcasting service goes over 2.5 million.

Cable TV broadcasting services are being digitalized as well. In France, most cable TV broadcasting services are digitalized in 1997. In the next year, 1998, England began to convert the cable broadcasting services into digital broadcasting services. Since June 2000, 12 countries are providing the digital cable broadcasting services. In the U.S., some states have provided the digital cable broadcasting service since 1998. Japan, too, has set up a plan to complete the digitalization of the cable broadcasting service by 2010.

As broadcasting media are digitalized, a digital settop box market comes into the spotlight recently. There may be various reasons for the rapidly emerging digital settop market, but the main reason may be that the digital broadcasting services necessitate settop boxes that mediate the connection between the Internet and TV.

Recent propagation of Fiber To The Home (FTTH) speeds up the transmission rate of an Internet subscriber network into hundreds of Mbps. This stimulates the research on services integrating broadcasting and communication which are provided via current broadcasting-only networks as well as communication services through the Internet. To take an example, researchers are studying Internet high definition TV (HDTV) broadcasting technology having a transmission rate of hundreds of Mbps, which integrates broadcasting with communication.

Generally, a broadcasting tuner for receiving cable broadcasting, terrestrial broadcasting and satellite broadcasting, which is mounted in the front part of a settop box, extracts high-frequency analog signals propagated for the purpose of broadcasting in accordance with a channel altering signal, converts the extracted high-frequency analog signals into digital signals, and transmits the digital signals to a decoder for a digital TV.

The conventional settop boxes having the terrestrial tuner do not include an Internet protocol tuner for supporting Internet broadcasting and communication service. So, they cannot process a service requiring wide bandwidth, such as high definition (HD) broadcasting service providing a plurality of channels through the Internet. In short, the conventional settop apparatuses do not have sufficient interface and return channel capacity to support multimedia services integrating broadcasting and communication and, thus, they cannot provide service requiring wide bandwidth such as multi-channel HDTV broadcasting service using the Internet.

To be specific, the conventional settop apparatuses for a digital TV has a tuner in the front part to receive cable broadcasting, terrestrial broadcasting and satellite broadcasting, selects high-frequency analog signals propagated for the purpose of broadcasting according to a channel altering signal of a user, converts them into digital signals, and transmits the digital signals to a decoder for a digital TV. The conventional settop apparatuses accommodate terrestrial or satellite broadcasting-only services through additional lines, and the interface for the Internet is limited to an additional low-rate return channel service. Therefore, they cannot accommodate diverse home network devices and they cannot accommodate services requiring wide bandwidth such as multi-channel HDTV service using the Internet.

Even if the conventional settop apparatuses for a digital TV can support the services requiring wide bandwidth, they necessitate an expensive processor to process network traffics, especially Internet traffics. In short, the problem is that they require an expensive high-performance processor to classify and extract broadcasting packets from received Internet packets. In addition, there is a problem that the broadcasting packets should be converted into transport stream.

### SUMMARY OF THE INVENTION

It is, therefore, an object of the present invention to provide an Internet protocol tuner that can classify Internet packets, which are transmitted through the Internet, into broadcasting packets and communication packets and extract transport stream from the broadcasting packets, and a method therefor.

In accordance with an aspect of the present invention, there is provided an Internet protocol tuner that can classify Internet packets into broadcasting packets and communication packets, including: a network interface unit for receiving an Internet packet, and transmitting an Internet packet generated in a packet generating unit to the Internet; a packet classifying unit for classifying an Internet packets received by the network interface unit into a broadcasting packet and a communication packet based on channel selecting information; a transport stream extracting unit for extracting transport stream from the broadcasting packet obtained in the packet classifying unit; a transport stream transmitting unit for transmitting the transport stream extracted in the transport stream extracting unit to a decoding unit; a transport stream receiving unit for receiving the transport stream from the decoding unit; a packet generating unit for generating an Internet packet by utilizing the transport stream received by the transport stream receiving unit; a controller interface unit for accessing to an external controller and transmitting control information from the controller to a tuning control unit; and the tuning control unit for controlling the packet classifying unit to classify the Internet packet into the broadcasting packet and the communication packet based on the channel selecting information when the Internet packet is received, and controlling the transport stream extracting unit to extract the transport stream from the broadcasting packet obtained in the packet classifying unit.

In accordance with another aspect of the present invention, there is provided a method for classifying Internet packets into broadcasting packets and communication packets in an Internet protocol tuner, including the steps of: a) receiving an Internet packet from the Internet at a network interface unit; b) classifying the Internet packet into a broadcasting packet and a communication packet based on channel selecting information at a packet classifying unit; c) transmitting the broadcasting packet to a transport stream extracting unit and the communication packet to a controller at a tuning control unit; d) extracting transport stream from the broadcasting packet at the transport stream extracting unit.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a settop box having an Internet broadcasting receiving function to which the present invention is applied;

FIG. 2 is a block diagram illustrating an Internet protocol tuner having a function of classifying an Internet packet into a broadcasting packet and a communication packet in accordance with an embodiment of the present invention;

FIG. 3 is a diagram showing a structure of an Internet packet in accordance with an embodiment of the present invention;

FIG. 4 is a flowchart describing a method for classifying an Internet packet into a broadcasting packet and a communication packet in an Internet protocol tuner in accordance with an embodiment of the present invention;

FIG. 5 is a flowchart illustrating a method for classifying an Internet packet in a packet Internet protocol tuner in accordance with an embodiment of the present invention; and

FIG. 6 is a flowchart describing a method for extracting transport stream (TS) in a transport stream extracting unit in accordance with an embodiment of the present invention.

### DETAILED DESCRIPTION OF THE INVENTION

Other objects and aspects of the invention will become apparent from the following description of the embodiments with reference to the accompanying drawings, which is set forth hereinafter.

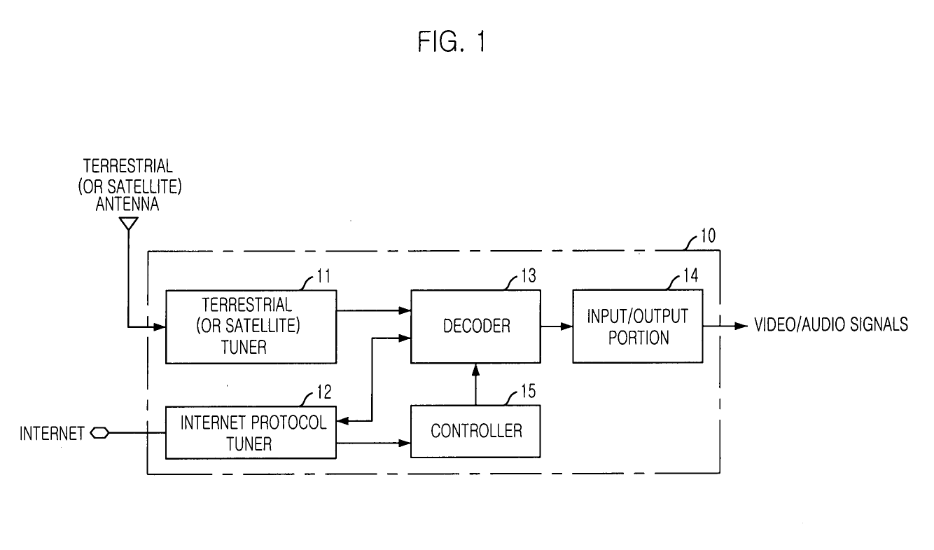

FIG. 1 is a block diagram showing a settop box having an Internet broadcasting receiving function to which the present invention is applied. The settop box having an Internet broadcasting receiving function includes a terrestrial (or satellite) tuner 11, an Internet protocol tuner 12, a decoder 13, an inputting/outputting portion 14, and a controller 15.

The terrestrial (or satellite) tuner 11 receives broadcasting signals, which are released from a broadcasting station, by using a terrestrial antenna and extracts transport stream. The Internet protocol tuner 12 classifies Internet packets into broadcasting packets and communication packets according to channel selecting information, and extracts transport stream from the broadcasting packets.

The decoder 13 divides the transport stream extracted by the terrestrial tuner 11 and the Internet protocol tuner 12 into video signals and audio signals according to the control of the controller 15. The inputting/outputting portion 14 outputs the video signals and audio signals and receives data signals used for an Internet service from a user.

The controller 15 controls the Internet protocol tuner 12 to extract transport stream from the Internet packets which are transmitted through the Internet and controls the decoder 13 to divide the transport stream, which are extracted from the terrestrial tuner 11 and the Internet protocol tuner 12, into video signals and audio signals.

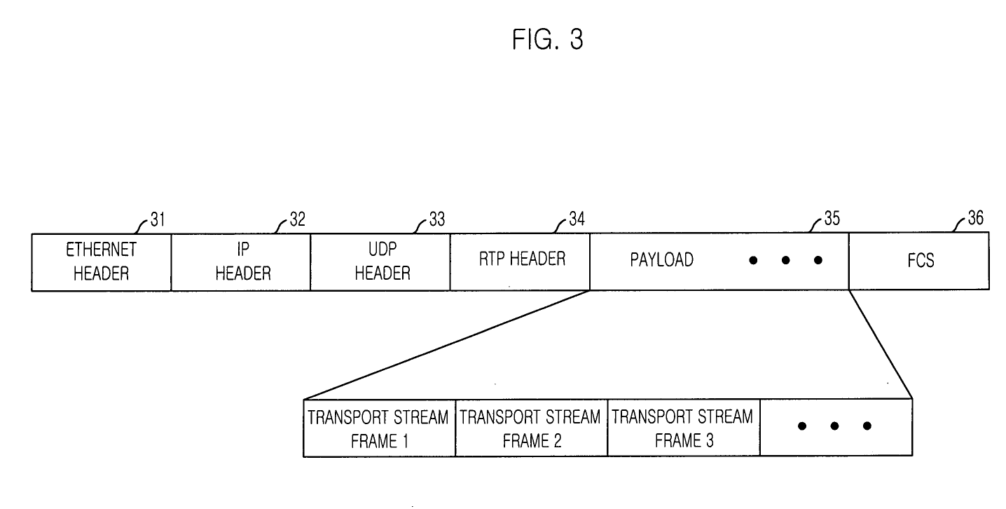

Channel information is information inserted into the Internet packets, such as Media Access Control (MAC) address, IP address, User Datagram Protocol (UDP) port number, as shown in FIG. 3. The channel selecting information is channel information inputted by the user. Internet packets have various channel information, and each service provider can provide a different service according to different channel information. In other words, a service provider can provide a service according to an MAC address or an IP address.

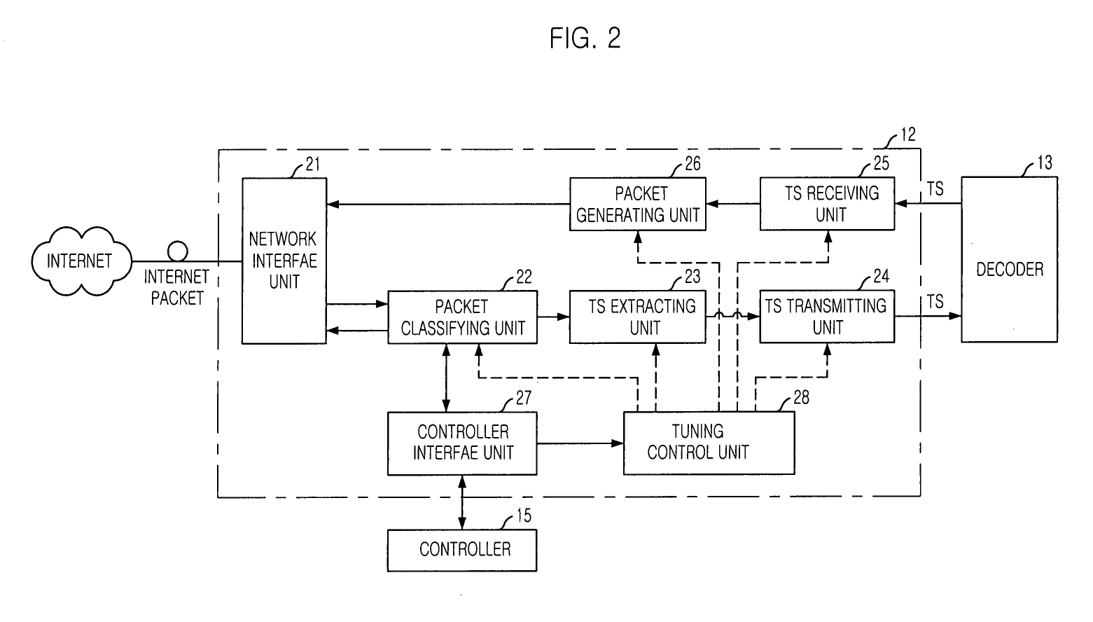

FIG. 2 is a block diagram illustrating an Internet protocol tuner having a function of classifying an Internet packet into a broadcasting packets and a communication packet in accordance with an embodiment of the present invention. The Internet protocol tuner having a function of classifying the Internet packet into a broadcasting packet and a communication packet includes a network interface unit 21, a packet classifying unit 22, a transport stream (TS) extracting unit 23, a transport stream transmitting unit 24, a transport stream receiving unit 25, a packet generating unit 26, a controller interface unit 27, and a tuning control unit 28.

The network interface unit 21 receives Internet packets from the Internet, transmits them to the packet classifying unit 22, and transmits Internet packets generated in the packet generating unit 26 to the outside through the Internet.

The packet classifying unit 22 classifies the Internet packet received by the network interface unit 21 into a broadcasting packet and a communication packet based on channel selecting information. The transport stream extracting unit 23 extracts transport stream from the broadcasting packet obtained in the packet classifying unit 22.

The transport stream transmitting unit 24 transmits the extracted transport stream to the decoder 13. The transport stream receiving unit 25 receives the transport stream from the decoder 13. The packet generating unit 26 generates an Internet packet by using the transport stream received by the transport stream receiving unit 25.

The controller interface unit 27 accesses to the controller 15 and transmits control information including channel selecting information from the controller 15 to the tuning control unit 28. The tuning control unit 28 controls based on the control information the packet classifying unit 22 to determines whether the internet packet is a broadcasting packet or a communication packet, when the internet packet is received, and controls the transport stream extracting unit 23 to extract transport stream from the broadcasting packet obtained in the packet classifying unit 22. The tuning control unit 28 controls the packet generating unit to generate an Internet packet based on IP address and MAC address received from the controller 15.

FIG. 3 is a diagram showing a structure of an Internet packet in accordance with an embodiment of the present invention. The internet packet includes an IP header 32, a User Datagram Protocol (UDP) header 33, a Real-time Transport Protocol (RTP) header 34, a payload 35 and an Frame Check Sequence (FCS) 36.

The IP header 32 includes an Ethernet header 31 containing an MAC address and an IP address, and the UDP header 33 includes a UDP port number. The RTP header 34 includes information for real-time transmission and the payload 35 has transport stream inserted on a frame by frame basis. The FCS 36 contains information for informing the end of a packet. Into the payload 35, a plurality of transport stream frames having more than 188 bytes are inserted.

The Ethernet header 31 and the FCS 36 are used when the Ethernet is used. If other protocol is used, a header for the protocol is inserted.

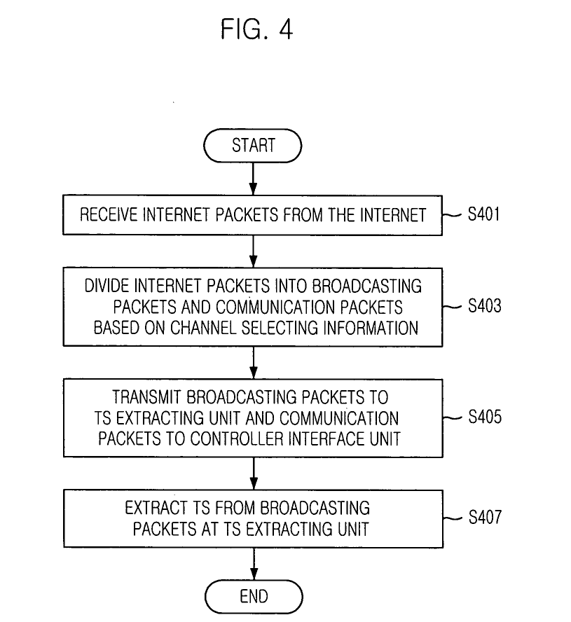

FIG. 4 is a flowchart describing a process for classifying an Internet packet into a broadcasting transport stream packet and a communication packet in the Internet protocol tuner in accordance with an embodiment of the present invention.

At step S401, the network interface unit 21 receives Internet packets from the Internet. The Internet packet received here includes both broadcasting packets and communication packets. At step S403, the packet classifying unit 22 classifies the Internet packets into broadcasting packets and communication packets.

Subsequently, at step S405, the tuning control unit 28 controls the packet classifying unit 22 to transmit broadcasting packets to the transport stream extracting unit 23 and the communication packets to the controller 15. At step S407, the transport stream extracting unit 23 extracts transport stream from the broadcasting packets.

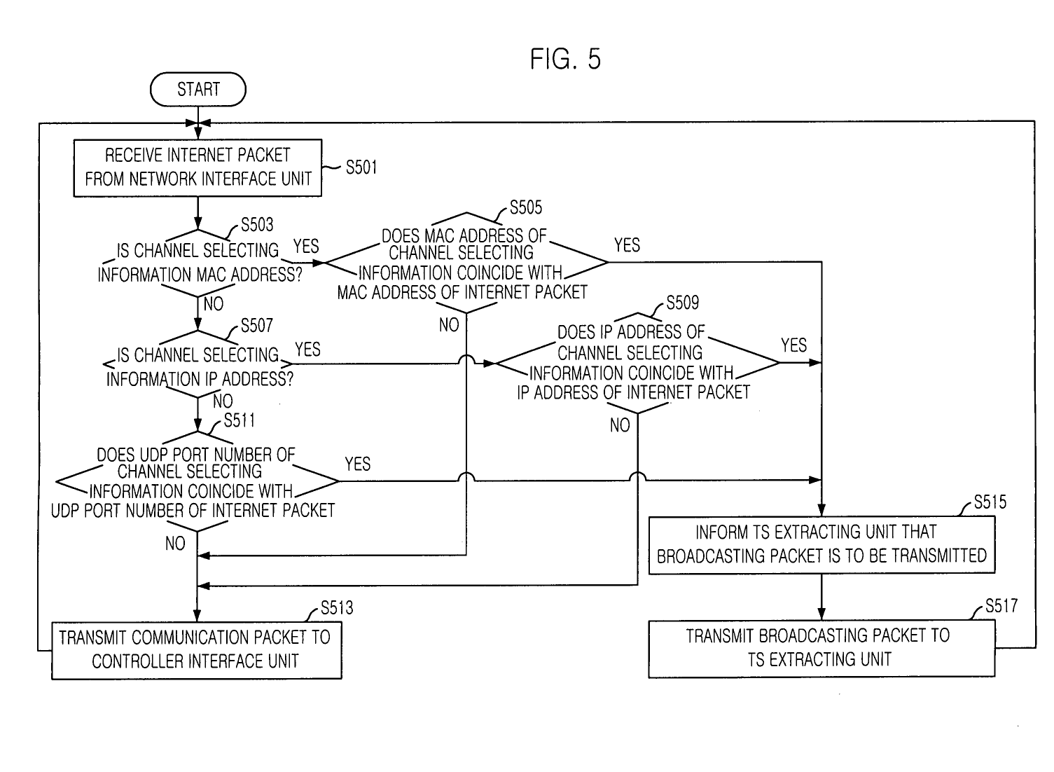

FIG. 5 is a flowchart illustrating a process for classifying an Internet packet in a packet Internet protocol tuner in accordance with an embodiment of the present invention. First, at step S501, an Internet packet is received from the network interface unit 21. Then, the packet classifying unit 22 classifies the Internet packet into a broadcasting packet and a communication packet based on channel selecting information, i.e., MAC address, IP address, or UDP port number. To be more specific, this process is described as follows.

At step S503, it is checked whether the channel selecting information is an MAC address. Then, if the channel selecting information is an MAC address, at step S505, the MAC address of the channel selecting information is compared with the MAC address of the Ethernet header 31 of an Internet packet.

If the two do not coincide with each other, at step S513, the Internet packet is recognized as a communication packet and transmitted to the controller interface unit 27. If they coincide, at step S515, the Internet packet is recognized as a broadcasting packet and the transport stream extracting unit 23 is informed of the transmission of the broadcasting packet. Then, at step S517, the broadcasting packet is transmitted to the transport stream extracting unit 23.

On the other hand, if it is determined at the step S503 that the channel selecting information is not an MAC address, at step S507, it is checked whether the channel selecting information is an IP address.

If the channel selecting information is an IP address, at step S509, the IP address of the channel selecting information is compared with the IP address of the IP header 32 of an Internet packet.

If the two IP addresses do not coincide with each other, at step S513, the Internet packet is recognized as a communication packet and transmitted to the controller interface unit 27. If they coincide, at step S515, the Internet packet is recognized as a broadcasting packet and the transport stream extracting unit 23 is informed of the transmission of the broadcasting packet. Then, at step S517, the broadcasting packet is transmitted to the transport stream extracting unit 23.

In the mean time, if it is turned out at the step S507 that the channel selecting information is not an IP address, at step S511, the UDP port number of the channel selecting information is compared with the UDP port number of the UDP header 33 of the Internet packet.

If the two UDP port numbers do not coincide with each other at the step S511, at step S513, the Internet packet is recognized as a communication packet and transmitted to the controller interface unit 27. If they coincide with each other, at step S515, the Internet packet is recognized as a broadcasting packet, and, at step S515, the transport stream extracting unit 23 is informed that the broadcasting packet is to be transmitted thereto. Then, the broadcasting packet is transmitted to the transport stream extracting unit 23.

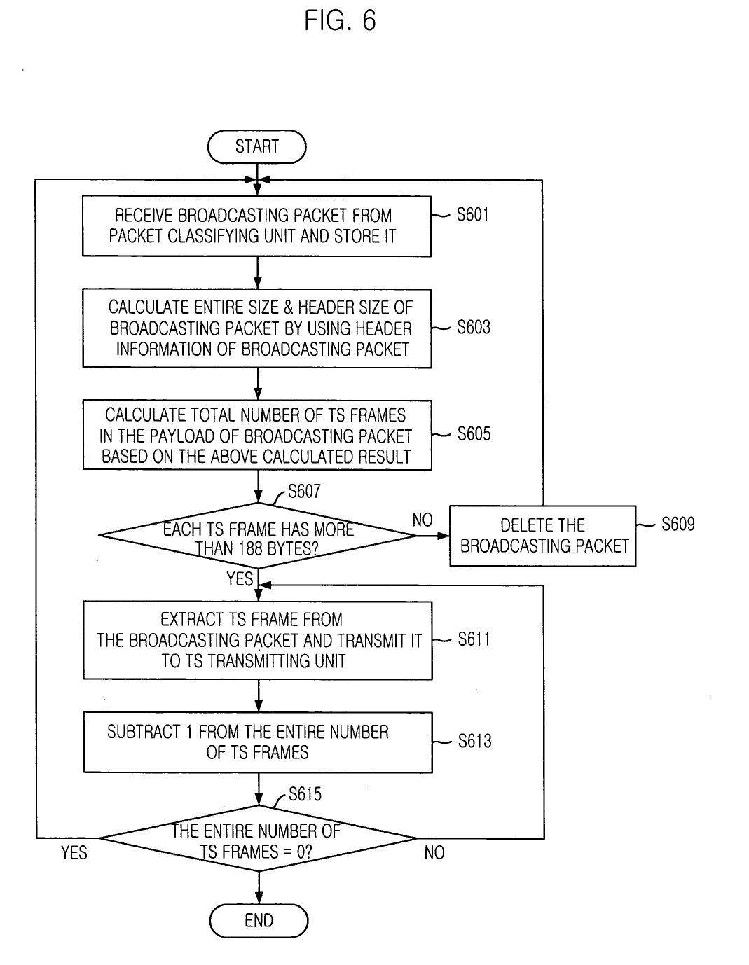

FIG. 6 is a flowchart describing a process for extracting transport stream in a transport stream extracting unit in accordance with an embodiment of the present invention. In the first place, at step S601, the transport stream extracting unit 23 receives the broadcasting packet obtained in the packet classifying unit 22 and stores the broadcasting packet in a storage (not shown) adopting a first-in-first-out (FIFO) method.

At step S603, the whole size of the broadcasting packet and the size of a header are calculated to obtain broadcasting packet and header amplitude information by using header information of the broadcasting packet stored in the storage. Then, at step S605, the total number of transport stream frames in the payload 35 of the broadcasting packet is calculated by using the broadcasting packet and header amplitude information.

At step S607, it is checked whether each of the transport stream frames in the payload 35 of the broadcasting packet exceeds 188 bytes. The payload 35 includes a plurality of transport stream frames and a normal broadcasting packet should have transport stream frames each of which has more than 188 bytes. The step S607 is a procedure for checking whether the internet packet is a normal broadcasting packet.

If each of the transport stream frames does not exceed 188 bytes at the step S607, at step S609, the broadcasting packet is deleted and the logic flow goes back to the step S601 and performs the subsequent steps. That is, a new broadcasting packet is received.

On the other hand, if each of the transport stream frames exceeds 188 bytes at the step S607, it means that the broadcasting packet is a normal broadcasting packet. Therefore, at step S611, transport stream frames are extracted from the broadcasting packet and transmitted to the transport stream transmitting unit 24. Then, at step S613, the total number of transport stream frames is reduced by one.

Subsequently, at step S615, it is checked whether the total number of transport stream frames is 0. If yes, it signifies that all transport stream are extracted from one broadcasting packet.

If the total number of transport stream frames is not 0 at the step S615, the logic flow goes to the step S611 and the subsequent steps are performed. This process is repeated until all the transport stream frames of one broadcasting packet are extracted.

If the total number of transport stream frames is 0 at the step S615, the logic flow goes to the step S601 and the subsequent steps are performed. That is, a new broadcasting packet is received and the process is performed with respect to the new broadcasting packet.

The technology of the present invention is applied to an IP settop box for processing broadcasting and communication services by utilizing the Internet. According to the present invention, digital broadcasting data can be received through the Internet by classifying Internet packets, extracting transport stream from the Internet packets, and transmitting the transport stream to a decoder for a digital TV.

The transport stream transmitted from the digital TV decoder are converted into a form of Internet packet and transmitted to the Internet.

Also, since the technology of the present invention reduces burden upon a processor through hardware processing without additional software processing, a conventional low-performance processor can be used. The technology of the present invention can provide users with video on demand (VOD).

While the present invention has been described with respect to certain preferred embodiments, it will be apparent to those skilled in the art that various changes and modifications may be made without departing from the scope of the invention as defined in the following claims.

1. An Internet protocol tuner that can classify Internet packets into broadcasting packets and communication packets, comprising:
a network interface means for receiving an Internet packet;
a packet classifying means for classifying the Internet packets received by the network interface means into a broadcasting packet and a communication packet based on channel selecting information;
a transport stream extracting means for extracting transport stream from the broadcasting packet obtained in the packet classifying means;
a transport stream transmitting means for transmitting the transport stream extracted in the transport stream extracting means to a decoding means;
a transport stream receiving means for receiving the transport stream from the decoding means;
a controller interface means for receiving control information including channel selecting information from an external controller; and
a tuning control means for controlling the packet classifying means to classify the Internet packet into the broadcasting packet and the communication packet based on the channel selecting information when the Internet packet is received, and controlling the transport stream extracting means to extract the transport stream from the broadcasting packet obtained in the packet classifying means.

2. The Internet protocol tuner as recited in claim 1, further comprising:
a packet generating means for generating an Internet packet by utilizing the transport stream received by the transport stream receiving means and transmitting the Internet packet to the Internet through the network interface means.

3. The Internet protocol tuner as recited in claim 1, wherein the Internet packet includes an Ethernet header having a Media Access Control (MAC) address, an Internet Protocol (IP) header having an IP address, a User Datagram Protocol (UDP) header having a UDP port number, a real-time transport protocol (RTP) header having information for real-time transmission, a payload with transport stream inserted thereto on a frame by frame basis, and a frame check sequence (FCS) having information notifying the end of an Ethernet frame.

4. A method for classifying Internet packets into broadcasting packets and communication packets in an Internet protocol tuner, comprising the steps of:
a) receiving an Internet packet from the Internet at a network interface unit;
b) classifying the Internet packet into a broadcasting packet and a communication packet based on channel selecting information at a packet classifying unit;
c) transmitting the broadcasting packet to a transport stream extracting unit and the communication packet to a controller at a tuning control unit;
d) extracting transport stream from the broadcasting packet at the transport stream extracting unit.

5. The method as recited in claim 4, wherein the step b) includes the steps of:
b1) comparing the channel selecting information with channel information of the Internet packet;
b2) if the channel selecting information coincides with the channel information of the Internet packet, determining the internet packet as a broadcasting packet and transmitting the broadcasting packet and a signal informing that the broadcasting packet is to be transmitted to the transport stream extracting unit; and
b3) if the channel selecting information does not coincide with the channel information of the transmitted Internet packet, determining the internet packet as a communication packet and transmitting the communication packet to a control interface unit.

6. The method as recited in claim 4, wherein the step d) includes the steps of:
d1) receiving the broadcasting packet from the packet classifying unit and storing the broadcasting packet in a storage adopting a first-in-first-out (FIFO) method;
d2) calculating the whole size of a broadcasting packet and a size of a header to thereby obtain broadcasting packet and header size information by using header information of the broadcasting packet stored in the storage, and calculating the total number of transport stream frames in a payload of the broadcasting packet by using the broadcasting packet and header size information;
d3) checking whether the transport stream stored in the payload of the broadcasting packet exceeds 188 bytes;
d4) if the transport stream stored in the payload of the broadcasting packet does not exceed 188 bytes, deleting the broadcasting packet;
d5) if the transport stream stored in the payload of the broadcasting packet exceeds 188 bytes, extracting transport stream frames from the broadcasting packet;
d6) reducing the total number of the transport stream frames by one;
d7) checking whether the total number of the transport stream frames is 0; and
d8) if total number of the transport stream frames is not 0, extracting transport stream frames from the broadcasting packet until the total number of the transport stream frames is 0.

7. The method as recited in claim 4, wherein the Internet packet includes an Ethernet header having a Media Access Control (MAC) address, an Internet Protocol (IP) header having an IP address, a User Datagram Protocol (UDP) header having a UDP port number, a real-time transport protocol (RTP) header having information for real-time transmission, a payload with transport stream inserted thereto on a frame by frame basis, and a frame check sequence (FCS) having information notifying the end of an Ethernet frame.
